(19) United States
(12) Patent Application Publication
(10) Pub. No.: US 2020/0143466 A1
(43) Pub. Date: May 7, 2020

(54) BLOCKCHAIN-BASED LENDING SYSTEMS AND METHODS

(71) Applicants: Jianxin Wu, Minneapolis, MN (US); Hanghang Qu, Minneapolis, MN (US)

(72) Inventors: Jianxin Wu, Minneapolis, MN (US); Hanghang Qu, Minneapolis, MN (US)

(21) Appl. No.: 16/675,626

(22) Filed: Nov. 6, 2019

Related U.S. Application Data
(60) Provisional application No. 62/756,245, filed on Nov. 6, 2018.

(51) Int. Cl. G06Q 40/02; H04L 9/06; G06Q 50/18

(52) U.S. Cl. CPC G06Q 40/025; H04L 9/0637; H04L 2209/38; H04L 2209/56; G06Q 50/188

(57) ABSTRACT

Systems may include an off-chain computing system and an on-chain computing system. Methods may include receiving a principal amount to lend or borrow based on input from a first user, storing offer data in an off-chain data structure, requesting recordation of a smart contract on a blockchain based on the offer data, confirming a first transaction of the principal amount or the collateral amount from the second user to the smart contract has been recorded on the blockchain, confirming a second transaction of the principal amount or the collateral amount complementary to the first transaction from the first user to the smart contract has been recorded on the blockchain, and confirming the smart contract has recorded a third transaction releasing the principal amount on the blockchain in response to confirming both the first transaction and the second transaction.

The present application claims the benefit of U.S. Provisional Application Ser. No. 62/756,245, filed Nov. 6, 2018, which is incorporated by reference.

The present technology is generally related to blockchain and, in particular, smart contracts deployed on blockchain.

Traditional financial infrastructure for payments, savings, and lending is a closed, centralized, and capital intense system. Capital movement and allocation between different systems is usually associated with high transaction cost and low efficiency, especially for across border and geographic movement. The capital-intensive nature may create high barriers to entry and power concentration, which can result in huge systematic risks and “too big to fail” problems. This may also curtail accessibility to financial services, leaving many people underserved financially. In addition, the labor-intensive nature of post-transaction settlement and reconciliation may mean that many financial services cannot be provided during off working hours, such as weekends and holidays. The innovation and exploration of automatically decentralized lending networks have lagged behind due to the much higher complexity of decentralized infrastructure and technology.

### SUMMARY

The techniques of the present disclosure generally relate to a digital lending platform with both a decentralized architecture and a decentralized governance process which may address many problems of traditional finance. The platform may provide an open, decentralized financial system that can perform financial transactions automatically without “custodian” involvement, and still ensure the security, integrity, and trust. The platform may facilitate greater efficiency, security, transparency, and accessibility of financing, as well as much lower cost, compared to traditional finance. The platform is designed to develop into a self-governed digital lending ecosystem for users worldwide to easily access new financial opportunities, secured by blockchain technology. Using an innovative cross-chain application that simplifies user experience through “Off-Chain Agreement Matching with On-Chain Settlement,” the digital lending platform provides a trustworthy platform for lending and borrowing digital assets without any intermediary interference. By providing 24/7 global accessibility with significantly lower than traditional lending costs, the platform may offer “crypto asset” holders the unique ability to unlock instant value from their digital capital. The platform may also connect different blockchains and sidechains simultaneously and smoothly without needing a trusted third party to form a digital ecosystem.

In one aspect, the present disclosure provides a method for lending or borrowing. The method includes receiving offer data relating to an offer to lend or borrow based on input from a first user. The method also includes storing the offer data in an off-chain data structure. The offer data has loan parameter values including at least a principal amount and a collateral amount. The method further includes, in response to receiving user input data representing acceptance of the offer from a second user, requesting recordation of a smart contract on a blockchain based on the offer data, wherein the smart contract comprises at least the principal amount and the collateral amount from the offer data, confirming a first transaction of the principal amount or the collateral amount from the second user to the smart contract has been recorded on the blockchain, confirming a second transaction of the principal amount or the collateral amount complementary to the first transaction from the first user to the smart contract has been recorded on the blockchain, and confirming the smart contract has recorded a third transaction releasing the principal amount on the blockchain in response to confirming both the first transaction and the second transaction.

In another aspect, the present disclosure provides a system for lending or borrowing. The system includes an off-chain computing system comprising processing circuitry and memory to store an off-chain data structure. The off-chain system is configured to: receive offer data relating to an offer to lend or borrow based on input from a first user, store the offer data in the memory of the off-chain computing system, and receive selection data representing acceptance of the offer based on input from a second user. The offer data has loan parameter values including at least a principal amount and a collateral amount. The system also includes an on-chain computing system comprising processing circuitry and memory. The on-chain computing system is configured to: request recordation of a smart contract on a blockchain based on the offer data, confirm a first transaction of the principal amount or the collateral amount from the second user to the smart contract has been recorded on the blockchain, confirm a second transaction of the principal amount or the collateral amount complementary to the first transaction from the first user to the smart contract has been recorded on the blockchain, and confirm the smart contract has recorded a third transaction releasing the principal amount on the blockchain in response to confirming both the first transaction and the second transaction. The smart contract includes at least the principal amount and the collateral amount from the offer data stored in the memory of the off-chain computing system.

In yet another aspect, the present disclosure provides a user interface system for lending or borrowing. The system includes a display to receive display data and display information to a user, a user input apparatus to receive user inputs and provide user input data, a communication interface to send and receive data operably couplable to an off-chain computing system and an on-chain computing system for blockchain recordation, and processing circuitry operably coupled to the display to provide display data, to the user input apparatus to receive user input data, and to the communication interface to send and receive data. The processing circuitry is configured to: display a marketplace interface to lend or borrow on the display; display one or more offers to lend or borrow in the marketplace interface based on offer data from the off-chain computing system, each offer comprising a principal amount, a principal unit type, a collateral amount, a collateral unit type and at least one of: an interest rate, a loan term, a loan total cost, and a number of installments; display an acceptance area selectable by the user to accept one of the one or more offers; display a counteroffer area selectable by the user to provide a counteroffer to one of the one or more offers; in response to selection of the acceptance, provide data to the on-chain computing system to record a smart contract to a blockchain based on offer data corresponding to the accepted offer; and in response to selection of the counteroffer, display a counteroffer interface for a user to input counteroffer data, and provide counteroffer data to the off-chain computing system.

Further details of the disclosure are set forth in the accompanying drawings and the description below. Other features, objects, and advantages of the techniques described in this disclosure will be apparent from the description, the drawings, and the claims.

### BRIEF DESCRIPTION OF THE DRAWINGS

FIG. 1 is a flow diagram that illustrates one example of a method for blockchain-based lending systems.

FIG. 2 is a conceptual diagram that illustrates one example of a digital lending platform and related functionality that may be used with the method of FIG. 1.

FIG. 3 is another conceptual diagram that illustrates the digital lending platform of FIG. 2.

FIG. 4 is yet another conceptual diagram that illustrates the digital lending platform of FIGS. 2-3.

FIG. 5 is a flow diagram that illustrates one example of a matching method that may be used in the method of FIG. 1 to facilitate loan agreement.

FIG. 6 is a flow diagram that illustrates one example of a settlement method that may be used in the method of FIG. 1 after users have agreed to loan terms and a smart contract is initialized.

FIG. 7 is a conceptual diagram that illustrates one example of a lending marketplace interface that may be used with the platform of FIGS. 2-4.

FIG. 8 is a conceptual diagram that illustrates one example of a borrowing marketplace interface that may be used with the platform of FIGS. 2-4.

FIG. 9 is a conceptual diagram that illustrates one example of an offer interface that may be used in the platform of FIGS. 2-4.

FIG. 10 is a conceptual diagram that illustrates one example of a counteroffer interface that may be used with the platform of FIGS. 2-4.

FIGS. 11-13 are conceptual diagrams that illustrate examples of settlement interfaces that may be used with the platform of FIGS. 2-4 to settle a loan smart contract after agreement.

### DETAILED DESCRIPTION

Various aspects of this disclosure relate to a system or method that provides a fully decentralized financial ecosystem to promote financial inclusion and efficiency with autonomous lending agreements secured through blockchain and smart contract technology in a digital lending platform. Using an innovative cross-chain decentralized application (DApp) that simplifies the user experience with “off-chain loan agreement matching with on-chain settlement,” the digital lending platform may provide a trustworthy ecosystem for users worldwide to securely lend and borrow digital assets. Unlike conventional lending, the platform may remove custodial risk and trusted intermediary interference by utilizing smart contracts to execute lending agreements on a highly decentralized blockchain. The platform can connect different blockchains and sidechains simultaneously and smoothly without needing a trusted third party to form a digital ecosystem.

Loan contracts on the platform may be automatically created and executed: once deployed, users or administrators of the platform may not have the ability to spend funds that are held in the smart contract (e.g., not released); control how to resolve, approve, or reject loan offers or requests; or undo, modify or cancel loan agreements, etc. In some embodiments, the role of the platform may be only to facilitate users to reach loan agreements and publish smart contracts for loans to a blockchain. In particular, the smart contract may be published to a permission-less blockchain, which may be accessed by anyone without permission or central administration. The decentralized architecture of the platform may effectively avoid the single point of failure problem, improve the reliability and accessibility of the network, and significantly increase the difficulty of cyber-attacks. The smart lending ecosystem may offer digital assets holders the unique ability to unlock instant value from their digital assets with better performance in terms of accessibility, speed, reliability, and security, and all at a much lower cost than through traditional financing.

The technique described as “off-chain agreement matching with on-chain settlement” is a hybrid solution, which combines the efficiency of centralized communication channels for reaching loan agreements, with near instant settlement of on-chain loan agreement implementation. In this approach, loan offers and requests may be broadcasted through the off-chain platform. An interested counterparty may submit one or more of these similar counteroffers off-chain, and the loan requester may modify, change, pause or cancel the loan request seamlessly. Once two parties agree on the loan contract terms, the settlement may happen on the blockchain instantly. Friction costs may be minimized for loan requesters because they can signal intent off-chain and smart contract-based transactions may occur only when a loan agreement is finalized.

The platform design allows for cross-chain compatibility to integrate with different blockchains through smart contract technology. A plurality of blockchains and sidechains may be used to provide a blockchain-based secure, decentralized, and scalable payment system with each with different features and functionality. Cross-chain compatibility may provide the ability to offer a more diverse range of crypto assets for lending (as opposed to only one cryptocurrency). Moreover, the platform may not need to function as a trusted custodian. Instead, user assets may be stored on the blockchain within a smart contract, so no single entity will have authority to touch those assets until certain pre-agreed conditions are met, which may reduce custodian risks, avoidance of cyber-attacks, and reduction in transaction costs.

In some embodiments, the systems and methods described herein may facilitate some or all of the following features: off-chain agreement matching with on-chain settlement, cross-chain lending, decentralized architecture, and decentralized governance. These features may provide benefits to users that are not found in existing lending systems.

Blockchain, also called a distributed ledger or distributed ledger technology (DLT), is an open, distributed database that can be used to record transactions among parties efficiently and in a verifiable and permanent way. In some implementations, blockchain systems sacrifice security and decentralization to gain scalability and improve transactions per second.

Bitcoin is a widely adopted global distributed public transaction ledger. It is an electronic payment system based on cryptographic proof instead of trust, allowing any two willing parties to transact directly with each other without using a trusted third party. Bitcoin has shown stability, reliability, efficiency, simplicity, and security to keep ownership records and transfer ownership from one user to another directly.

As used herein, the term “smart contract” refers to a set of promises, specified in digital form, including protocols within which the parties perform on these promises. (Szabo. Formalizing and Securing Relationships on Public Networks. 1997.) Blockchains may be used to provide a decentralized, secure, immutable, and reliable computing system to write, deploy, and execute smart contracts. With second generation blockchain technology, contract terms can be written in a computer language instead of legal language, can be deployed in a computing network, and can be automatically executed by a suitable distributed ledger system.

Blockchain may be used to provide a decentralized, secure, immutable, and reliable computing system to write, deploy and execute smart contracts. Distributed ledger networks with built-in functionality to support complex smart contracts may be written, deployed, and executed and may be described as “second generation blockchains,” such as ETHEREUM, STELLAR, HYPERLEDGER, and NEO blockchains. Smart contract terms can be written in a computer language instead of legal language, can be deployed in a computing network, and can be automatically executed by a suitable distributed ledger system. In some embodiments, smart contracts are built upon an ETHEREUM blockchain.

DApps may be built on top of the second generation blockchain. Smart contracts and decentralized applications may be described as characteristics of a second generation blockchain not available in a first generation blockchain.

As used herein, a decentralized application, or “DApp,” may be described as an application having backend code running on a decentralized peer-to-peer network in contrast to a centralized server. Backend code may also be described as “contracts” or decentralized logic. DApps may have frontend code to provide user interfaces, which make calls to their backend, or contracts, to connect with and interact with blockchains. Frontend code may use HTML, CSS, or JavaScript to render a web-based user interface. Frontend code may be hosted on decentralized storage, which may also be described as a distributed storage platform, such as a Swarm platform or an InterPlanetary File System (IPFS) platform. DApps may utilize decentralized messaging, which may use, for example, a Whisper protocol. In some embodiments, DApps are built on an ETHEREUM blockchain.

DApps may be used to facilitate the ease of issuing and managing “digital assets.” Digital assets may be described as programmable assets that exist in the form of electronic data. The digitization of assets may be decentralized, trustful, transparent, and free of intermediaries by using blockchain technology. Digital assets may capture and store value like a traditional asset but formed digitally using blockchain technology. Digital assets formed using blockchain technology may be described as “crypto digital assets” or “crypto assets.”

Crypto assets may be categorized into different categories based on a difficulty of adoption of the blockchain technology. For example, crypto asset categories may include but are not limited to: cryptocurrency, digitalized traditional financial assets, digitalized fiat currencies, digitalized intangible assets, digitalized tangible assets, and digitalized conventional service and products. In some embodiments, one or more of these categories of crypto assets may be used for lending or borrowing on the platform.

Cryptocurrency is a type of digital asset, which may be issued by entrepreneurs to fund venture startup costs of a blockchain-related platform. Typically, an initial coin offering (ICO) is used to issue cryptocurrency and commits to accept only that cryptocurrency as payment for future access to a digital platform. Other forms of issuing cryptocurrencies like proof of work mining and pre-mining, proof of stake mining, pre-mining, etc. are also commonly used by startups. Cryptocurrency may be described as a type of asset which represents the value and rights for a promised service to be developed by utilizing blockchain technology.

Digitalized traditional financial assets are a digital form of conventional financial assets like equities, fixed incomes, exchange-traded funds (ETFs), real estate investment trusts (REITs), derivatives, etc. Digitalized financial assets may allow anyone to own and transfer financial assets across an open financial network without the use of a trusted third party. Throughout the lifecycle of an equity trade financial intermediaries may be involved, such as stock exchanges and trading venues, broker-dealers, custody banks, and the Depository Trust Company.

Digitalized fiat currencies are a digital form of fiat currencies like the US dollar, the Euro, the Japanese Yen, etc., which exist on a distributed ledger network. These digital fiat currencies can be owned, transferred, and exchanged without the involvement of a trusted custodian like a retail bank.

Digitalized intangible assets are a digital form of intangible assets which are issued and managed through blockchain. Intangible assets like reward cards, royalty, copyrights, patents, trademarks, gaming points, credit scores, etc. can be digitalized with blockchain technology.

Digitalized tangible assets are a digital form of tangible assets of which the ownership and rights are digitalized, issued, distributed, and managed through the blockchain. Tangible assets like real estate, commodities, lumber lands, etc. can be used as underlying assets to back a digital token issued by a trusted custodian. The price of these tokens may be pegged to the underlying asset, and the token can be traded, cleared, and settled on the blockchain, which may eliminate the intermediaries like an exchange venue, a dealer, and a broker, etc. Also, the high divisibility of digitalized tangible assets may facilitate being broken down to smaller units that can be used in exchange and transparently transfer ownership. Non-limiting examples of digitalized tangible assets include stablecoins, such as petrol coin, gold coin, etc.

Digitalized conventional service and products are a digital form of service and products which are issued by companies or individuals on the blockchain to represent their products or service. Once the products and service are digitalized, they may be used to trade and settle payment instantly on the blockchain, which may significantly reduce the transaction cost and trade settlement cycle of the point of sale.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar.

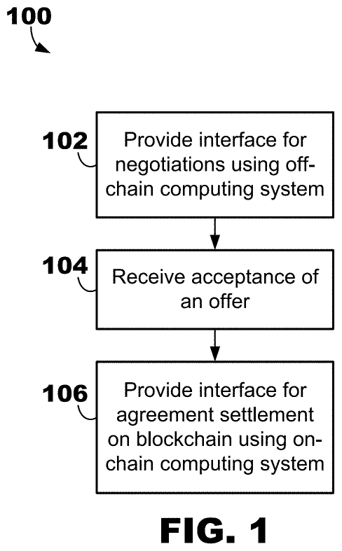

FIG. 1 shows one example of a method 100 for blockchain-based lending systems. In general, borrowers may be interested in borrowing funds in a particular currency, or crypto asset unit, and may offer collateral in a different currency. Lenders may be interested providing funds in a particular currency and earning a premium, or return on investment, for the lost opportunity cost of lending their funds. Collateral from the borrower may be used to mitigate risk for the lender. Collateral may be transferred to the lender if the borrower defaults on the loan.

The method 100 may provide an interface for negotiations using an off-chain computing system 102 (e.g., off-chain matching). Use of blockchain during the negotiation phase may incur spending “gas,” which may be described as measure of computational effort to execute operations on a blockchain, each time a loan is posted, modified, or cancelled. Instead of using a blockchain to manage negotiations, the method 100 may use an off-chain computing system to facilitate negotiations.

As used herein, the term “off-chain computing system” may describe a system or part of a system configured to interact with data stored in an off-chain data structure that is not part of a blockchain.

The method 100 may also receive an acceptance of an offer or counteroffer 104. Two users may negotiate by a first user providing an offer. The second user may accept the offer or provide a counteroffer. The first user may accept the counteroffer or provide another counteroffer. This may continue until one of the users accepts one of the offers or counteroffers from the other user. In one example, the first user may offer to lend an amount of a crypto asset, and the second user may accept the offer to borrow the amount of the crypto asset.

Further, the method 100 may provide an interface for agreement settlement on a blockchain using an on-chain computing system 106 (e.g., on-chain settlement). Once the users have agreed to terms, a smart contract may be recorded, or deployed, on a blockchain, such as an ETHEREUM blockchain. The smart contract may contain details about the offer or counteroffer that was accepted and may facilitate enforcing the terms of the loan, such as when to fund, collateralize, and make payments on the loan.

The blockchain may act as a bookkeeper. In some embodiments, a permission-less blockchain may be used for bookkeeping, including recordation of the smart contracts. For example, a distributed public ledger network, such as ETHEREUM, STELLAR, HYPERLEDGER, EOS, etc., may provide bookkeeping services to facilitate transparent execution of loan contracts. In return, the network may be rewarded with gas fees. For example, users may pay to create, record, deploy, or otherwise generate a loan smart contract on the blockchain using the on-chain computing system. Users may or may not need to pay to negotiate or communicate using the off-chain computing system.

As used herein, the term “on-chain computing system” may describe a system or part of a system configured to interact with data stored in an on-chain data structure, such as a blockchain.

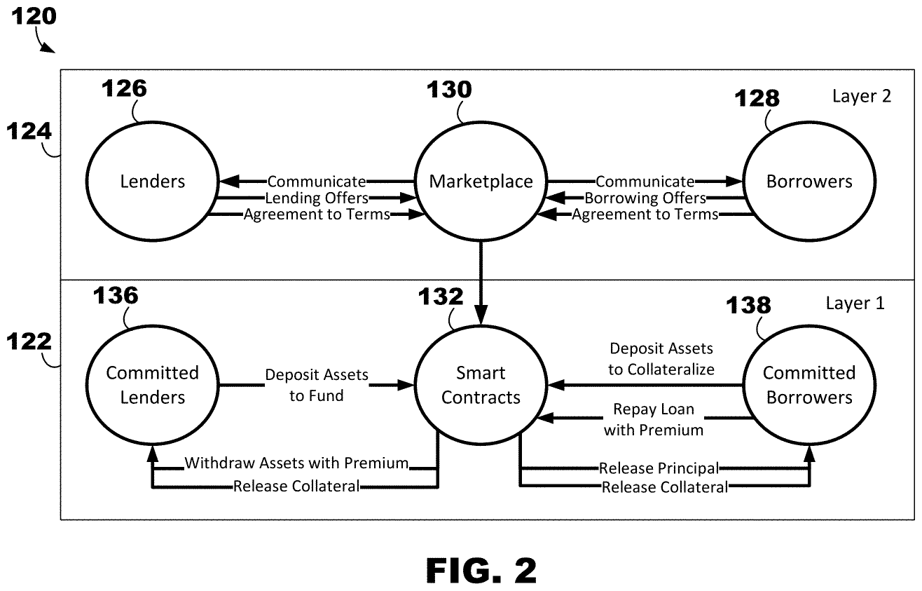

FIG. 2 is a conceptual diagram showing one example of a digital lending platform 120 and related functionality that may be used with the method 100 of FIG. 1. The platform 120 may include a first layer 122 (Layer 1) and a second layer 124 (Layer 2). As illustrated, the first layer 122 includes functionality of an on-chain computing system. The second layer 124 includes functionality of an off-chain computing system.

“On-Chain Loan Agreement Settlement Layer” is the smart contract and agreement enforcement layer to ensure the loan contract is written and executed on a distributed public ledger network correctly. Every time a smart contract is created, or generated, users may pay to generate the smart loan contract.

Users of the platform 120 may be categorized as lenders 126 and borrowers 128. A single user may be both a lender in one loan and a borrower in another loan on the platform 120. The lenders 126 and borrowers 128 may interact using an interface of a marketplace, or marketplace interface 130. The marketplace interface 130 may be used to communicate to lenders 126 and borrowers 128, receive offers and counter offers to lend or borrow, and receive an agreement to an offer from lenders or borrowers.

Any suitable types of loans may be offered on the marketplace interface 130. In some embodiments, the marketplace interface 130 may include one or more of the following: term loans with a fixed personal interest rate; demand loans with a floating standard interest rate; and term loans with a floating or fixed standard interest rate. Term loans with fixed personal interest rates may define one or more of: a set loan amount, a specified repayment schedule, and a fixed interest rate. Demand loans with a floating standard interest rate may define a set loan amount and a floating interest rate without a repayment schedule. Term loans with a floating or fixed standard interest rate may define one or more of: a set loan amount, a detailed repayment schedule, and a floating or fixed standard interest rate.

The marketplace interface 130 may be deployed on a DApp interface, or user interface, which serves as a gateway to interact with DApps that run on the blockchain. The DApp interface may allow users to hold digital assets, manage identities, and sign blockchain transactions. Non-limiting examples of DApp interfaces include digital asset wallets, “web 3.0” browsers, centralized and decentralized digital asset exchanges, digital asset casinos, etc. Lenders 126 and borrowers 128 may use any suitable DApp interface to process and complete transactions on the platform 120 to access the digital assets lending marketplace.

In some embodiments, lenders 126 may provide assets for lending. Lenders 126 may be described as giving up the opportunity cost of their financial assets to give borrowers access to crypto assets. Borrowers 128 may use the borrowed assets to fund their projects and get a return in reward and contribute the premium to the platform 120. The platform 120 may be used to facilitate the loan negation process to reach loan agreements in the second layer 124 and may write and deploy loan smart contracts 132 on the blockchain in the first layer 122 upon agreement reached in the marketplace interface 130 by a lender 126 and a borrower 128.

Interaction with the blockchain in the first layer 122 may provide a digital infrastructure of trust to ensure the integrity of transactions and immutability. Upon deploying the smart contract 132, a committed lender 136 may deposit crypto assets into the smart contract 132 to fund the loan and the committed borrower 138 may deposit crypto assets into the smart contract to collateralize the loan. Once the smart contract 132 is funded and collateralized, the smart contract may release principal to the committed borrower 138. The committed borrower 138 may make one or more payments to repay the loan with a premium (e.g., interest over time). The committed lender 136 may withdraw assets from the smart contract 132 from the payments. Once the last payment is made by the committed borrower 138, the smart contract 132 may release the collateral back to the committed borrower. If the committed borrower 138 defaults on the loan (e.g., does not make a payment), the smart contract 132 may release the collateral to the committed lender 136.

The platform 120 provides a pre-agreement service to help users to gather information, facilitate communication, find counterparties, negotiate and reach loan agreements on the second layer 124 (Layer 2 for “Off-Chain Loan Agreement Matching”) The priority for the second layer 124 may be to ensure the effectiveness of communication and match loan supply and demand. In some embodiments, the second layer 124 may run on a centralized server at the to provide a traditional web-based service and keep a low cost before reaching loan agreement. In other embodiments, the second layer 124 may be moved to a more decentralized network without sacrificing service level and low cost.

The second layer 124 may have a modular design and may be standardized to easily integrate with systems of other entities like decentralized exchanges, forum, communities, etc. In some embodiments, in order to provide a liquid loan marketplace and a secondary loan marketplace in the future, the platform 120 may be a public platform where all the digital loan providers can broadcast loan requests and offers in the marketplace 130. Broadcasting loans may allow anyone to act as a loan marketplace and keep loan records, without building and maintaining the full function of a trust settlement layer. Other entities can build a customized Layer 2 including some or all modules of the second layer 124 to facilitate the ease of integration.

Lenders 126 and borrowers 128 may post loan requests and offers that are managed in the second layer 124, which may be executed and implemented on the first layer 122 as loan smart contracts 132 upon agreement. The second layer 124 may facilitate interaction between market participants by hosting and propagating loan offers, counter offers, and associated messages. The second layer 124 may process information and providing a communication service for a plurality of digital assets across different blockchains. The second layer 124 may not execute loan agreement on behalf of market participants, and therefore may not require market participants to trust this layer.

In general, all loan agreements reached may be translated to a smart contract 132, deployed, and implemented on the blockchain using the first layer 122 (Layer 1 for “On-Chain Loan Agreement Settlement”). The first layer 122 may be described as the trust layer to ensure the loan contract is written and executed on the decentralized public ledger network correctly. The priority of the first layer 122 may be trust.

In some embodiments, the first layer 122 may include a Decentralized Trust Virtual Machine (DTVM) to generate and deploy loan smart contracts 132 on the blockchain after getting input from matched off-chain loan agreements in the second layer 124.

The first layer 122 may include a plurality of DTVMs. One DTVM may be designed to generate smart contracts 132 on one blockchain, which may be built on top of a first blockchain (e.g., an ETHEREUM blockchain). In order to provide cross chain lending service for the full spectrum of digital assets, the first layer 122 may also build or include one or more DTVMs on one or more other blockchains (e.g., BITCOIN, EOS, STELLAR, HYPERLEDGER, etc.).

The one or more DVTMs may be used in any suitable manner. In some embodiments, lenders 126 and borrowers 128 may submit their lending or borrowing proposal to the second layer 124 of the platform 120. Based on the available information, lenders 126 and borrowers 128 may be free to offer and counteroffer. Once an agreement is reached, the loan contract based on the offer or counteroffer that was accepted may be submitted to the DTVM in the first layer 122 and deployed on the blockchain by the first layer. Through DTVM to the blockchain, committed borrowers 128 may be required to deposit the digital collateral, and committed lenders 136 may be required to deposit lending assets or principal. Once these two criteria are met, the DTVM in the first layer 122 may execute the contract based on the loan agreement. Upon paying back the principal and premium by the borrowers to the lenders, the DTVM in the first layer 122 may release collateral back to the borrowers and close the contract. If loan defaults happen, the DTVM may release the collateral to lenders and close the smart contract 132.

The platform 120 may include any suitable number of modules, in some embodiments, a module of the platform 120 may include a local hypertext transfer protocol (HTTP) proxy application programming interface (API) that other applications or command line tools can use to interact with the smart contract creator of the first layer 122. Another module of the platform 120 may include messaging, which may be available using a remote procedure call API encoded in JavaScript Object Notation (RPC-JSON API). Yet another module of the platform 120 may include public gateways to servers, which may demonstrate functionality and allow free access so that people can write a loan agreement smart contract without even running their own smart contract generator.

Assets may be digitalized into crypto assets using any suitable technique. In some embodiments, assets may be digitalized for use on the platform 120 by third party providers. Once assets become digitalized, users can own, trade, transfer, borrow, and lend their assets in a secure, instant, and low-cost method without relying on any third party. The platform 120 may provide an autonomous borrowing and lending solution for digital assets including crypto assets.

Users, such as such as lenders 126 and borrowers 128 and committed lenders 136 and committed borrowers 138, may use a digital identity that may be established using any suitable technique to facilitate negotiation and agreement. In some embodiments, blockchain digital identity providers may provide autonomous identities for users using decentralized techniques. Such digital identity providers may provide identity management and regulatory compliance, which may allow digital asset lenders to issue compliant loans globally on blockchain without forcing borrowers to expose personal information. The platform 120 may be configured to provide feedback data to decentralized identity management providers. The identity may correspond to an address, such as a blockchain address.

Users of the platform 120 may use a credit score that may be established using any suitable technique to facilitate credit risk assessments. In some embodiments, Blockchain credit score providers may provide autonomous credit scores for users using decentralized techniques. Credit scores may allow digital asset lenders 126 to understand the counterparty risks better before comitting. Credit scores may facilitate determining appropriate interest rates and optimal loan-to-collateral ratios for each borrower. At the same time, loan history and transactions on the platform 120 may be used to provide feedback to the credit score providers for their credit score data input.

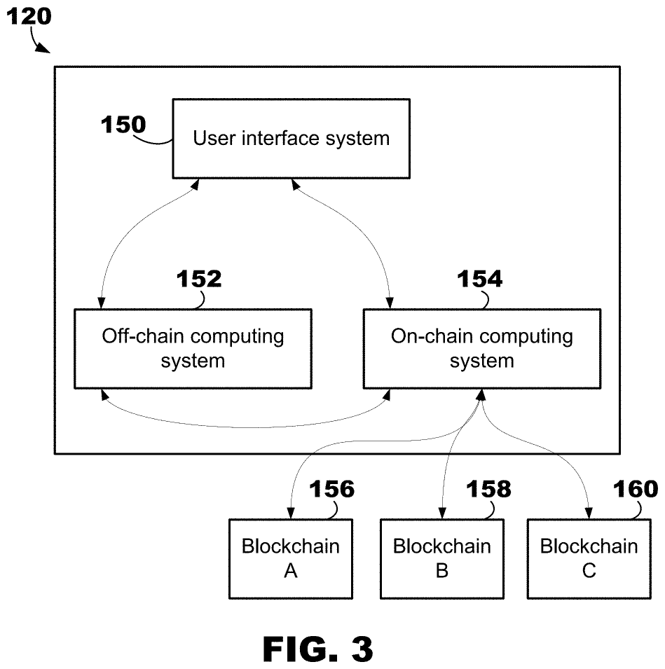

FIG. 3 is a different conceptual diagram showing the digital lending platform 120 of FIG. 2. The platform 120 may include one or more of the following: a user interface system 150, an off-chain computing system 152 to store data in an off-chain data structure (e.g., a centralized or decentralized database, stored locally, remotely, or on the cloud), and an on-chain computing system 154 to record data to one or more blockchains, such as blockchain A 156, blockchain B 158, or blockchain C 160. Although the off-chain computing system 152 and the on-chain computing system 154 are shown separately, in some embodiments, the systems may be operated by a single computing system configured to perform both functionalities.

In some embodiments, the on-chain computing system 154 may facilitate cross-chain lending. For example, a lender may wish to provide funds in crypto assets on blockchain A 156, which a borrower may wish to receive in a loan and use crypto assets on blockchain B 158 to collateralize the loan. The loan smart contract may be recorded on any suitable blockchain, which may be the same (blockchain A 156 or blockchain B 158) as one of the crypto assets or different than the crypto assets (blockchain C 160). The smart contract may record transactions on one or more of the blockchains 156, 158, 160 using the on-chain computing system 154. For example, when a principal amount of crypto assets from blockchain A 156 is transferred to the smart contract recorded on blockchain C 160, the smart contract may record data related to the transaction on blockchain A 156 and on blockchain C 160.

The user interface system 150 may include any suitable devices, apparatuses, or other systems to interact with users. In some embodiments, the user interface system 150 may include one or more of the following: a display, a user input apparatus, a communication interface, and processing circuitry.

The user interface system 150 may include a display to receive display data and display information to users. For example, the DApp may display a visual interface for the marketplace interface 130 on a display, such as a smartphone screen or computer monitor.

Also, the user interface system 150 may include a user input apparatus to receive user inputs and provide user input data. For example, the DApp may display selections, or options, with the marketplace interface 130 that are user selectable, for example, by a touchscreen on a smartphone or a keyboard connected to a computer.

Further, the user interface system 150 may include a communication interface to send and receive data. The communication interface may operably couple the user interface 150 to the off-chain computing system 152 or the on-chain computing system 154.

In some embodiments, the user interface system 150 may include processing circuitry operably coupled to the other components, such as the display to provide display data, the user input apparatus to receive user input data, and to the communication interface to send and receive data.

In some embodiments, a DApp frontend may run on the user interface system 150 to provide the user interface for the marketplace interface 130 (FIG. 2) for lending or borrowing. The DApp frontend may display the user interface on the display and accept user selections on the user input apparatus. User selections may be provided as user input data from the user input apparatus to the processing circuitry. The DApp frontend on the user interface system 150 may communicate with the DApp backend running on the on-chain computing system 154, which interact with at least one of the blockchains, such as blockchain A 156, blockchain B 158, or blockchain C 160.

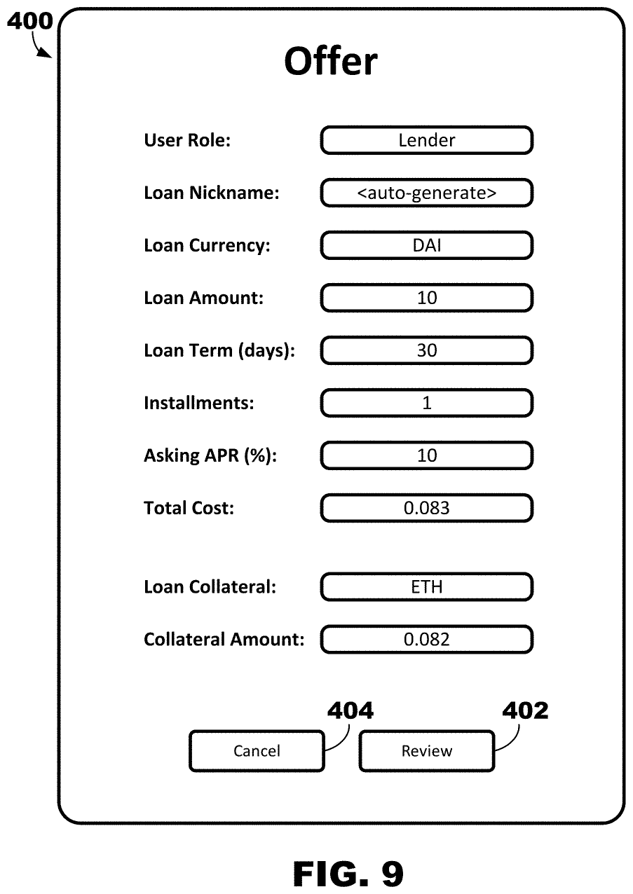

In some embodiments, the processing circuitry of the user interface system 150 may be used to display one or more offers to lend or borrow in the marketplace interface 130. The offers displayed may be based on offer data from the off-chain computing system 152. Each offer in the offer data may include information, or parameters, such as: a principal amount, a principal unit type (e.g., a type of crypto asset), a collateral amount, a collateral unit type (e.g., a type of crypto asset, which may be different than the principal unit type), an interest rate, a loan term, a loan total cost, and a number of installments. The offer data received using the user interface system 150. The processing circuitry may display an offer interface 400 (see FIG. 9) for the user to input offer data.

In some embodiments, the platform 120 may be configured to facilitate only cross-chain loans, in which the principal unit type and the collateral unit type are different. The processing circuitry may reject the offer data in response to the principal unit type being the same as the collateral unit type. For example, the offer interface may not allow the user to submit the offer.

In some embodiments, a minimum collateral amount may be enforced for each loan. In one example, when a borrower does not have an established credit score, a default or nominal minimum of collateral may be calculated and enforced. The minimum collateral amount may be based on a default or nominal percentage, such as 150 percent, multiplied by the principal amount and converted to the collateral unit type. In another example, a borrower may have an established credit score, and a minimum collateral may be calculated based on the credit score and enforced. The minimum collateral amount may be based on a particular percentage based on the credit score, such as a percentage between 100 and 200, multiplied by the principal amount and converted to the collateral unit type. Although percentages and multiplication are described, any suitable technique to apply a minimum a collateral amount may be used.

In some embodiments, the platform 120 may automatically determine the minimum collateral amount based on at least the principal amount, the type of principal currency, and the type of collateral currency. The minimum collateral amount may be displayed by the user interface system 150. The processing circuitry may reject the offer data in response to the user input collateral amount being less than the minimal collateral amount. For example, the offer interface may not allow the user to submit the offer.

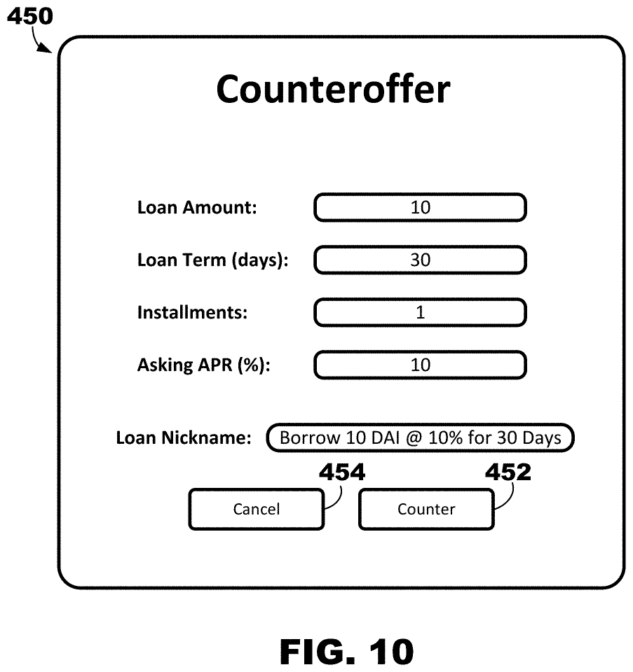

The marketplace interface 130 may include the display of an acceptance option for each of the offers for the user to accept the corresponding offer. Further, the marketplace interface 130 may include a counteroffer option for each of the offers for the user to provide a counteroffer to the corresponding offer. In response to user input indicating selection of the acceptance option, the processing circuitry may provide data to the on-chain computing system 154 to record a smart contract to one of the blockchains 156, 158, 160 based on the offer data. In response to user input indicating selection of the counteroffer option, the processing circuitry may display a counteroffer interface 450 (see FIG. 10) for a user to input counteroffer data and may provide counteroffer data to the off-chain computing system 152. Counteroffer data may include some or all of the information, or parameters, contained in the offer data.

One or more of the elements described herein, such as systems, interfaces, or controllers, may include processing circuitry, which may also be described as a processor, a central processing unit (CPU), a computer, a logic array, or other device capable of directing data coming into or out of the particular element. These elements may also include hardware to provide memory and communication. Functions of these elements be performed by hardware or as computer instructions on a non-transient computer readable storage medium.

Processing circuitry may include one or more of components, such as a microprocessor, a microcontroller, a digital signal processor (DSP), an application specific integrated circuit (ASIC), a field-programmable gate array (FPGA), or equivalent discrete or integrated logic circuitry. In some examples, processing circuitry may include multiple components, such as any combination of these components. The functions attributed to processing circuitry may be embodied as software, firmware, hardware, or any combination thereof.

Program code and/or logic described herein may be applied to input data/information to perform functionality described herein and generate desired output data/information. The output data/information may be applied as an input to one or more other devices and/or methods as described herein or as would be applied in a known fashion. In view of the above, it will be readily apparent that the controller functionality as described herein may be implemented in any manner known to one skilled in the art.

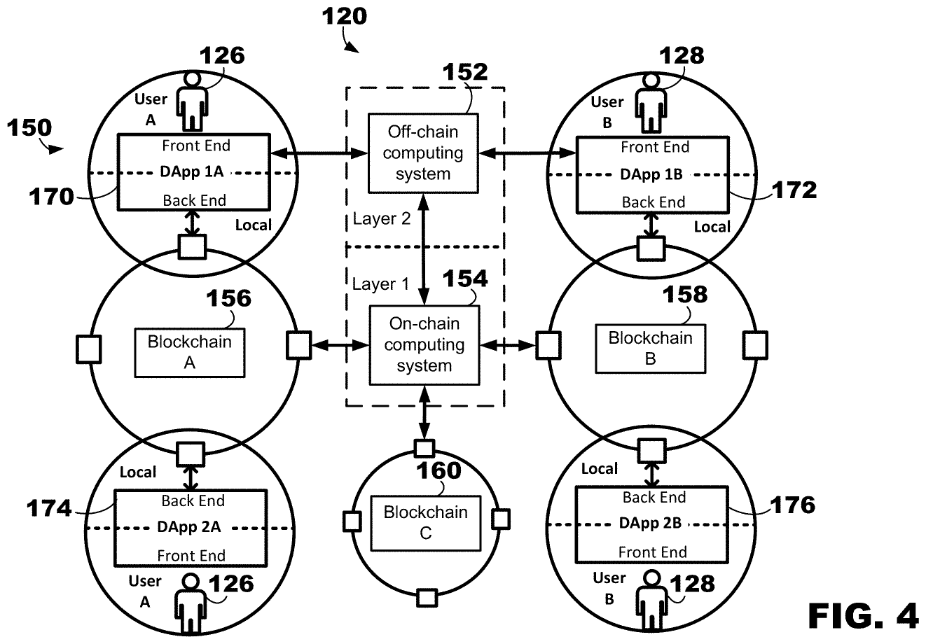

FIG. 4 is a different conceptual diagram showing the digital lending platform 120 of FIGS. 2-3. The platform 120 may include the off-chain computing system 152, the on-chain computing system 154, and the user interface system 150 deployed using DApps 170, 172 on distributed computing systems. As illustrated, each of the DApps, including DApps 170, 172 of the platform 120 and third party DApps 174, 176, may include a frontend that runs on local hardware and a backend that interacts with a respective blockchain.

In the illustrated embodiment, the DApps 170, 172 are in communication with the off-chain computing system 152. In particular, the frontends of the DApps 170, 172 are in communication with the off-chain computing system 152. Offer data may be used to display the marketplace interface 130 (FIG. 2) on the user interface system 150 using the frontends of the DApps 170, 172. The backends of the DApps 170, 172 are in communication with their respective blockchains 156, 168. In particular, DApp 170 is in communication with blockchain A 156, and DApp 172 is in communication with blockchain B 158.

A borrower 128 may using the frontend of the DApp 172 to provide an offer to borrow a principal amount of a crypto asset on blockchain A 156 (e.g., having a principal unit type based on blockchain A 156) collateralized by a crypto asset owned by the borrower on blockchain B 158 (e.g., having a collateral unit type based on blockchain B 158). The offer data may be provided from the DApp 172 to the off-chain computing system 152. The off-chain computing system 152 may provide the offer data to the marketplace interface 130, which may be displayed on one or more DApps connected to the off-chain computing system, such as the DApps 170, 172.

A lender 126 using DApp 170 may agree to lend the principal amount to the borrower 128. The acceptance may be provided as user input data from the DApp 170 to the off-chain computing system 152. The off-chain computing system 152 may provide data to the on-chain computing system 154, including the offer data and identifiers for the lender 126 and the borrower 128, to deploy a corresponding loan smart contract to the blockchain C 160. Although connecting lines are not shown, the backends of the DApps 170, 172 may also be in communication with the blockchain C 160.

A lender 126 using DApp 170 may alternatively provide a counteroffer in the form of counteroffer data. The counteroffer data may be provided as user input from the DApp 170 to the off-chain computing system 152. The off-chain computing system 152 may provide the counteroffer data to the marketplace interface 130, which may be displayed on one or more DApps connected to the off-chain computing system, such as the DApps 170, 172. In some embodiments, the off-chain computing system 152 may send a notification to the borrower 128 through the DApp 172 that the offer has been countered and may also provide the counteroffer data to the borrower.

If the borrower 128 accepts the counteroffer, the off-chain computing system 152 may provide data to the on-chain computing system 154, including the counteroffer data and identifiers for the lender 126 and the borrower 128, to deploy a corresponding loan smart contract to the blockchain C 160.

If the borrower 128 decides to counteroffer the counteroffer, the process can continue until at least one of the lender 126 and the borrower 128 agrees to loan terms offered by the other party. The process may also and when the lender 126 or the borrower 128 does not respond to or specifically declines the offer or a counteroffer from the other party.

Once the smart contract is deployed to the blockchain C 160, the loan may be funded and collateralized by the appropriate users. In some embodiments, for example, when the lender 126 accepts an offer to borrow from the borrower 128, the lender may provide the principal amount to the smart contract followed by the borrower providing the collateral amount to the smart contract. On the other hand, when the borrower 128 accepts an offer to lend from the lender 126, the borrower may provide the collateral amount to the smart contract followed by the lender providing the principal amount to the smart contract.

Sending crypto assets to the smart contract may be performed in any suitable manner. In some embodiments, the DApps 170, 172 may be used to send the principal amount or the collateral amount to the smart contract by direct interaction with the blockchain C 160 or by interaction through the on-chain computing system 154. In some embodiments, a third-party DApp, such as DApps 174, 176 may be used to send the principal or the collateral amount to the smart contract by direct interaction with the blockchain C 160. The DApps 174, 176 may interact with the off-chain computing system 152 to receive data, such as the smart contract address and the corresponding offer or counteroffer data agreed upon by the parties. The “smart contract address” may be used to reference the smart contract on the blockchain (e.g., blockchain user address). One example of a third party DApp is a digital wallet, such as the METAMASK digital wallet.

In the illustrated embodiment, the DApp 174 accessible by the lender 126 is in communication with blockchain A 156, and the DApp 176 accessible by the borrower 128 is in communication with blockchain B 158. The same lender 126 may interact with both DApps 170, 174, and the same borrower 128 may interact with both DApps 172, 176.

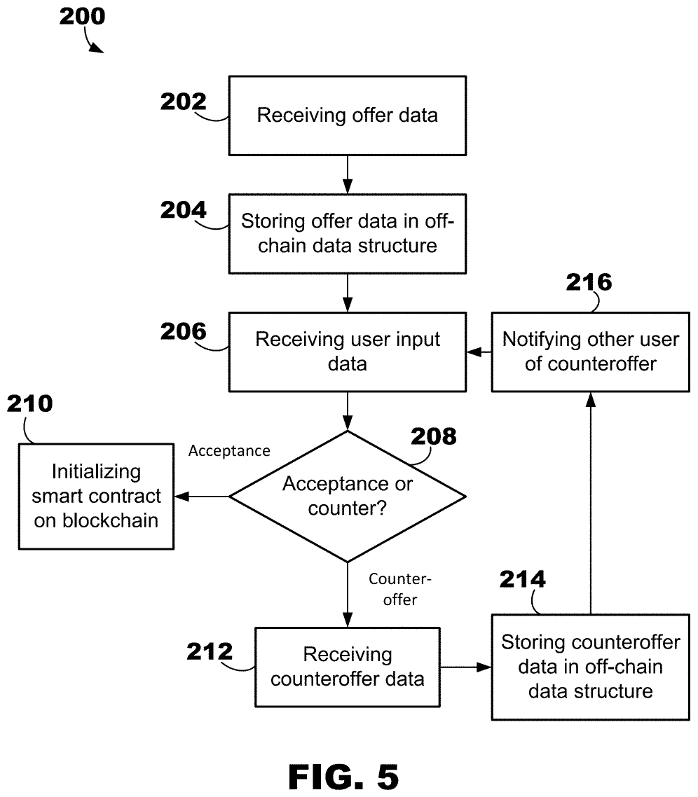

FIG. 5 is a flow diagram showing one example of a matching method 200 that may be used in the method 100 of FIG. 1. Some or all of the method 200 may be performed by an off-chain computing system. The method 200 may include receiving offer data 202. The offer data may include a principal amount to lend or borrow based on input from a first user. The offer data may be received by an off-chain computing system.

The method 200 may also include storing offer data in an off-chain data structure 204. The off-chain data structure may be stored on the off-chain computing system. In some embodiments, the offer data may include loan parameter values, such as a loan nickname (or other identifier), a lender identifier (e.g., blockchain user address), a borrower identifier (e.g., blockchain user address), principal amount, a principal unit type, a collateral amount, a collateral unit type, an interest rate, a loan term, a loan total cost, and a number of installments.

Further, the method 200 may include receiving user input data 206. The user input data may be selection data from a second user. The user input data may be received by the off-chain computing system.

The method 200 may include determining whether the user input data represents an acceptance or a counteroffer 208, for example, by the second user. The off-chain computing system may make the determination.

The method 200 may also include initializing a smart contract on a blockchain 210, for example, in response to determining that the user input data represents an acceptance by the second user. Initializing the smart contract may include the off-chain computing system sending loan parameter values to an on-chain computing system.

Instead of accepting the offer, the second user may want to change one or more loan parameter values in the offer data. The method 200 may further include receiving counteroffer data 212, for example, in response to determining that the user input data represents a counteroffer by the second user. The counteroffer data may be received by the off-chain computing system. The counteroffer data may include one or more of the loan parameter values from the offer data and at least one or more of the loan parameter values in the counteroffer data may be different than the corresponding loan parameter values in the offer data.

Furthermore, the method 200 may include storing the counteroffer data in the off-chain data structure 214. In some embodiments, the counteroffer data may be shown as a new offer in the marketplace.

The first user may be notified of the counteroffer 216 in the method 200. The notification may be provided by the off-chain computing system.

The first user may be provided an opportunity to accept or counter the counteroffer. The method 200 may return to receiving user input data 206 after notifying the first user of the counteroffer. The user input data may indicate whether the first user accepts or wants to counter the counteroffer.

The method 200 may continue to loop around 206, 208, 212, 214, and 216 until one of the users accepts a counteroffer from the other user. In response to a user input indicating acceptance, the method 200 may continue to initialize the smart contract on the blockchain 210 based on the counteroffer data.

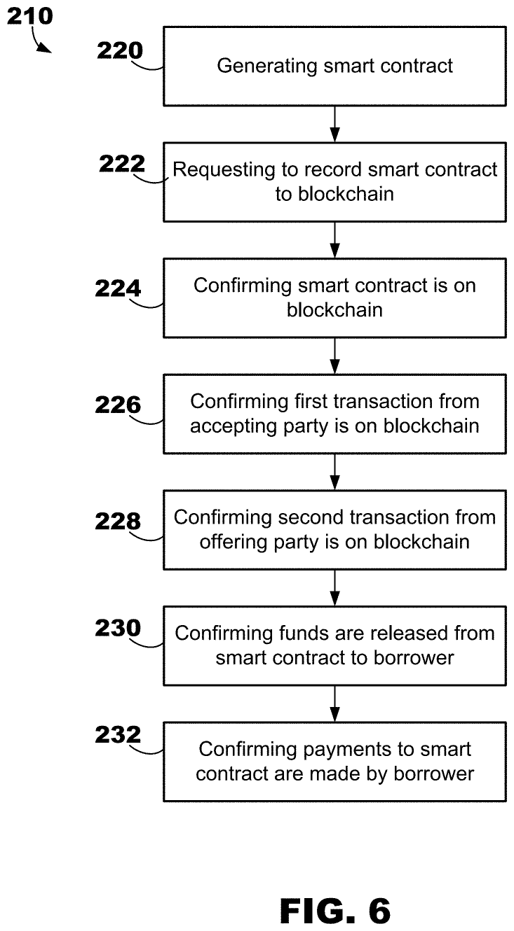

FIG. 6 is a flow diagram showing one example of a settlement method 200 that may be used in the method 100 of FIG. 1 after users have agreed to loan terms and a smart contract is initialized. Some or all of the method 200 may be performed by an on-chain computing system.

The method 200 may include generating the smart contract 220. The smart contract may be generated by a DTVM of the on-chain computing system using loan parameter values. The smart contract may include at least at least the principal amount and the collateral amount.

The method 200 may also include requesting recordation of the smart contract on a blockchain 222, for example, after generating the smart contract. The blockchain may be a permission-less blockchain. The on-chain computing system may request that the smart contract be recorded to the blockchain.

Further, the method 200 may include confirming that the smart contract is on the blockchain 224, for example, after requesting recordation of the smart contract. There may be a time delay between the request and the deployment of the smart contract on the blockchain. It may take some time (e.g., a few seconds or minutes) for the smart contract to be acknowledged by the blockchain as the smart contract is deployed to all the nodes in the blockchain network. Once the smart contract is acknowledged on the blockchain, a smart contract address may be assigned.

The smart contract address may be provided from the on-chain computing system to the off-chain computing system and may also be provided to the lender or borrower. In some embodiments, the method 200 may include requesting recordation of a first transaction to the smart contract (not shown). Users may use the smart contract address and a third party DApp to directly transfer crypto assets to the smart contract. In other embodiments, users may use the DApp of the platform to request recordation directly or through the on-chain computing system.

The method 200 may include confirming that a first transaction from the accepting party is on the blockchain 226. The on-chain computing system may be used to confirm that the first transaction is on the blockchain. The accepting party is the party who accepts the offer or counteroffer. The first transaction may include a principal amount from the lender if the accepting party is the lender. The first transaction may include a collateral amount from the borrower if the accepting party is the borrower.

The method 200 may also include confirming that a second transaction from the offering party is on the blockchain 228. The offering party is party who made the offer or counteroffer that was accepted. The on-chain computing system may be used to confirm that the second transaction is on the blockchain. In some embodiments, the method 200 may include requesting recordation of a second transaction to the smart contract (not shown), for example, before confirming that the second transaction is on the blockchain.

The second transaction may include a collateral amount from the borrower if the offering party is the borrower. The second transaction may include a principal amount from the lender if the offering party is the lender. The second transaction is complementary to the first transaction. For example, if the first transaction is principal, then the second transaction is collateral, and vice versa.

Further, the method 200 may include confirming funds are released from the smart contract to the borrower 230. The on-chain computing system may be used to confirm that the funds are released. The smart contract may record a third transaction to release the principal to the borrower. The on-chain computing system may provide the confirmation to the users upon request using the off-chain computing system or the DApp.

In addition, the method 200 may include confirming payments to the smart contract are made by the borrower. The on-chain computing system may be used to confirm that the funds are released. The borrower may record payment transactions each time a payment is made on the loan.

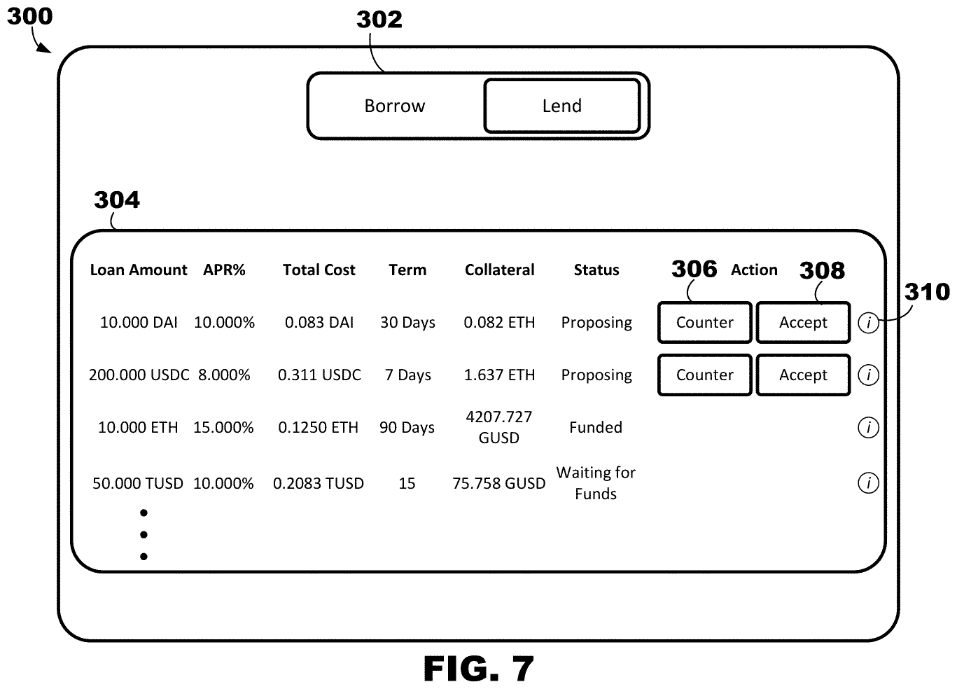

FIG. 7 is a conceptual diagram showing one example of a lending marketplace interface 300 that may be used in the marketplace interface 130 (FIG. 2) and displayed on the user interface system 150 (FIG. 3). The lending marketplace interface 300 may be displayed on screen, such as a smartphone screen or computer monitor. Although certain user selectable elements are shown and described, any suitable user selection elements may be used including selectable areas, regions, text hyperlinks, buttons, toggles, radio elements, checkboxes, etc.

The marketplace interface 300 may include a borrowing or lending option 302. The borrowing or lending option 302 may be displayed as a togglable element. The user may select whether to browse lending offers (as a borrower) or borrowing offers (as a lender). As illustrated, the borrowing or lending option 302 has the lend option selected, which represents browsing as a lender who wants to see borrowing offers.

The marketplace interface 300 may include an offer region 304 displaying one or more offers based on offer data. As illustrated, the offer region shows one or more offers to borrow. Each offer may be displayed as a different row. A header for each row may also be displayed. Each loan parameter may be displayed in a separate column with the loan parameter values associated with each offer. In the illustrated embodiment, the loan parameters displayed in the offer region 304 include a loan amount, an interest rate (APR %), a total cost (or premium), a loan term, and a collateral amount.

The offer region 304 may also display a status of each offer. Non-limiting examples of offer statuses include: proposing, funded, waiting for funds, waiting for collateral, closed, or cancelled. The proposing status may indicate that the offer is waiting for another user to accept. The funded status may indicate that agreement has been reached, a smart contract has been deployed, and both parties have sent funds to the smart contract. The waiting for funds status may indicate that the lender has not yet sent funds to the smart contract. The waiting for collateral status may indicate that the borrower has not yet send collateral to the smart contract. The closed status may indicate that the loan has been repaid. The cancelled status may indicate that one or both of the users did not fund the smart contract within a suitable time period or that the borrower has defaulted on payments.

Further, the offer region 304 may include a column for actions that the user may take with respect to each offer. As illustrated, the actions provided in the offer region 304 may include a counteroffer option 306 (counter) and an acceptance option 308 (accept). One or both of the counteroffer option 306 and the acceptance option 308 may be displayed as selectable area. The user may select the counteroffer option 306 to display a counteroffer interface 450 (see FIG. 10). The user may select the acceptance option 308 to initialize a smart contract.

Some or all of the offer data may be displayed in the offer region 304. As illustrated, the offer region 304 displays only some of the offer data that may be available. The user may select an information option 310, which is displayed as a selectable area, for each offer. More information about the offer may be provided by the user in an information interface (not shown).

Although the loan parameter values are shown with three digits after the decimal place any suitable number of digits after the decimal place may be used to provide the appropriate detail for lenders and borrowers. In some embodiments, at least four digits after the decimal place may be displayed.

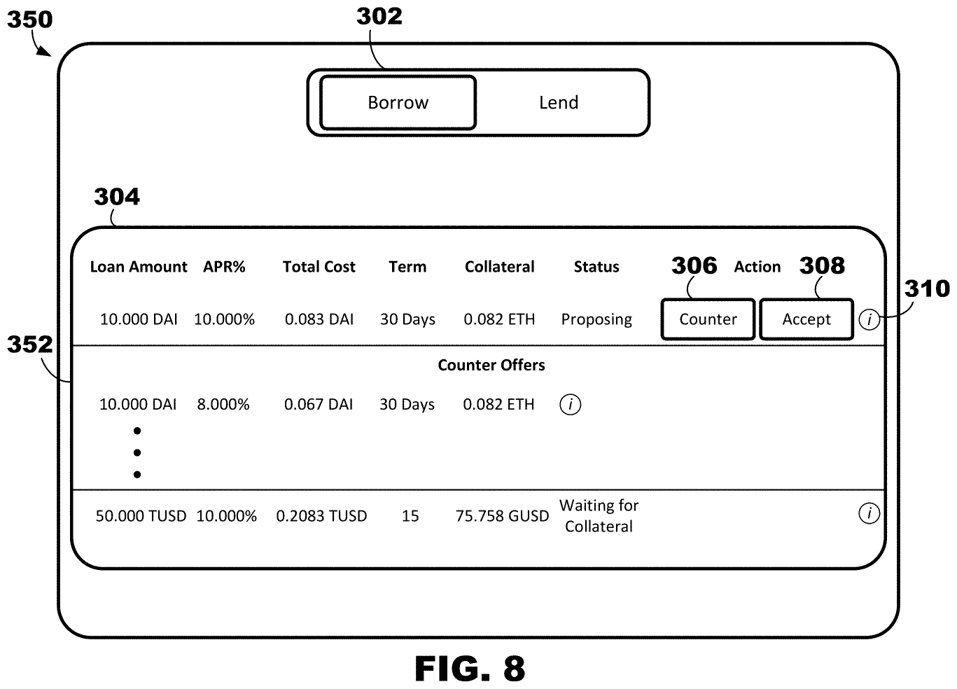

FIG. 8 is a conceptual diagram showing one example of a borrowing marketplace interface 350 that may be used in the marketplace interface 130 (FIG. 2) and displayed on the user interface system 150 (FIG. 3). The borrowing marketplace interface 350 may be the same or similar to the lending marketplace 300 except that the borrowing or lending option 302 indicates the borrow option selected, which represents browsing as a borrower who wants to see lending offers. Accordingly, as illustrated, the offer region 304 displays one or more offers to lend. Each offer may also be countered or accepted using the respective elements for the counteroffer option 306 and acceptance option 308. More information may also be provided using the information option 310.

The user may also choose to see counteroffers that have been made for each offer. In some embodiments, the user may click, select, or otherwise interact with the row corresponding to the offer (e.g., where there is text corresponding to the offer) except where there is another selectable area, such as counteroffer option 306 acceptance option 308, and information option 310. Upon such interaction with the row, a counteroffer region 352 may appear within the offer region 304 below the row corresponding to the offer. This functionality may also be provided on the lending marketplace interface 300.

The counteroffer region 352 may show some or all counteroffers that have been made for a particular offer. The counteroffer region 352 may show some or all of the loan parameters shown for each offer in the offer region 304.

FIG. 9 is a conceptual diagram showing one example of an offer interface 400 that may be used with the marketplace interface 130 (FIG. 2) and displayed on the user interface system 150 (FIG. 3). The same design of the offer interface 400 may be used for both borrowers and lenders.

The offer interface 400 may display loan parameters and user input fields to collect loan parameter values. In the illustrated embodiment, the loan parameters included in the offer interface 400 are: user role (e.g., lender or borrower), loan nickname (e.g., may be auto-generated based on other loan parameter values or manually input by user), principal unit type (loan currency), principal amount (loan amount), loan term, number of installments, interest rate (asking APR&%), total cost (or premium), collateral unit type (loan collateral), and collateral amount.

The offer interface 400 may also include one or more user selectable elements. As illustrated, the offer interface 400 includes an option to review the offer 402 before publishing the offer to the marketplace interface and an option to cancel the offer 404.

FIG. 10 is a conceptual diagram showing one example of a counteroffer interface 450 that may be used with the marketplace interface 130 (FIG. 2) and displayed on the user interface system 150 (FIG. 3). The same design of the counteroffer interface 450 may be used for both borrowers and lenders.

The counteroffer interface 450 may display loan parameters and user input fields to collect loan parameter values. In the illustrated embodiment, the loan parameters included in the counteroffer interface 450 are: principal amount (loan amount), loan term, number of installments, interest rate (asking APR&%), and the loan nickname. As illustrated, the auto-generated nickname may be based on some of the loan parameter values.

The counteroffer interface 450 may also include one or more user selectable elements. As illustrated, the counteroffer interface 450 includes an option to counter the offer 452 and an option to cancel the counteroffer 454.

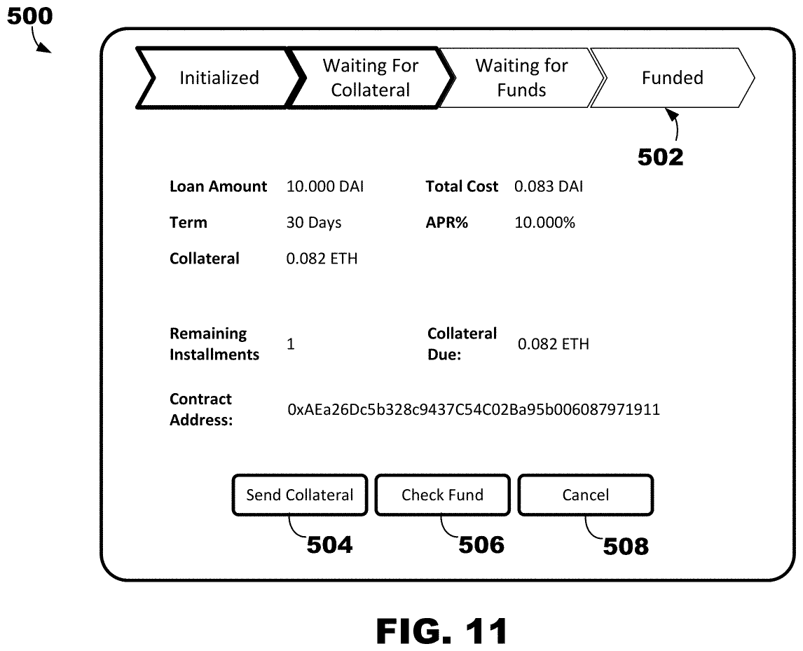

FIGS. 11-13 show examples of settlement interfaces 500, 520, 540 that may be used to settle a loan smart contract after agreement. The sequence shown is designed for settlements in which a borrower accepts an offer to lend. In some embodiments, the same interfaces may be used for settlements in which a lender accepts an offer to borrow by exchanging the order so that the smart contract receives principal (funds) from the lender followed by receiving collateral from the borrower.

FIG. 11 is a conceptual diagram showing one example of a first settlement interface 500 that may be displayed on the user interface system 150 (FIG. 3) after a borrower accepts an offer to lend. The first settlement interface 500 may be displayed to the borrower.

The first settlement interface 500 may include a status indicator 502. As illustrated, the status indicator 502 may a plurality of chevrons. Certain chevrons may be highlighted to indicate the current status. In the illustrated embodiment, the current status of the status indicator 502 is waiting for collateral to be sent to the smart contract.

The first settlement interface 500 may display one or more loan parameter values. The remaining number of installments to be paid may be shown to help the borrower manage payments. Other information about the loan may also be shown, such as the loan nickname, the loan creation date, and a unique loan identifier (which may be a Layer 2 address, different than the Layer 1 smart contract address).

The smart contract address may also be shown. The smart contract address may be used as an input to a third party DApp, for example, to send crypto assets to the smart contract.

The first settlement interface 500 may also include one or more user selectable elements, such as a send collateral option 504, a check fund option 506, and a cancel option 508. The send collateral option 504 may be used to ask the platform to request recordation of a transaction of crypto assets from the borrower to the smart contract to collateralize the loan. Once the collateral has been sent to the smart contract, the borrower may wait for the lender send principal to fund the loan.

The check fund option 506 may be used to check the status of the smart contract. For example, to confirm whether the transaction to collateralize the loan has been acknowledged by the blockchain. Once acknowledged, the status indicator 502 may be updated to waiting for funds.

The cancel option 508 may be used to cancel the loan. In some embodiments, the cancel option 508 may not appear until the borrower has sent collateral to the smart contract and waited for a period of time for the lender to send funds. For example, after sending collateral, the borrower may need to wait 3 days for the cancel option 508 to become available on the first settlement interface 500.

In some embodiments, the smart contract may automatically cancel the loan if the borrower has not sent collateral within a period of time or if the lender has not sent funds within a period of time. For example, after accepting the offer, if the borrower has not sent collateral within 5 days, the smart contract may automatically cancel the loan. Likewise, if after the borrower has sent collateral, if the lender has not sent principal to fund the loan within 5 days after collateral is received, the smart contract may automatically cancel the loan. Such cancellations may impact the credit score of the user who causes the automatic cancellation.

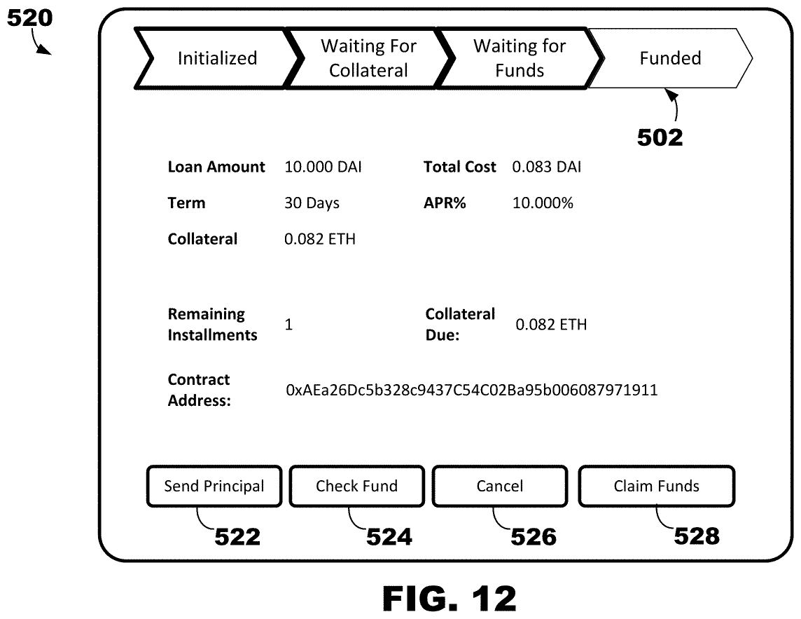

FIG. 12 is a conceptual diagram showing one example of a second settlement interface 520 that may be displayed on the user interface system 150 (FIG. 3) after a borrower sends collateral to the smart contract. The second settlement interface 520 may be displayed after the first settlement interface 500. The second settlement interface 520 may be displayed to the lender.

In the illustrated embodiment, the current status of the status indicator 502 is waiting for funds to be sent to the smart contract. This status may automatically update after the borrower has sent funds to the smart contract to collateralize the loan.

The second settlement interface 550 may display one or more loan parameter values, which may be the same or similar to the loan parameter values shown in the first settlement interface 500. The remaining number of installments to be paid may be shown to show the lender the progress of the loan payments. Other information about the loan may also be shown, such as the loan nickname, the loan creation date, and the unique loan identifier (which may be a Layer 2 address, different than the Layer 1 smart contract address).

The smart contract address may also be shown. The smart contract address may be used as an input to a third party DApp, for example, to send crypto assets to the smart contract.

The second settlement interface 550 may also include one or more user selectable elements, such as a send principal option 552, a check fund option 524, a cancel option 526, and a claim funds option 528. The send principal option 522 may be used to ask the platform to request recordation of a transaction of crypto assets from the lender to the smart contract to fund the loan. Once the funds have been sent to the smart contract, the lender may wait for the borrower to begin making payments.

The check fund option 524 may be used to check the status of the smart contract. For example, to confirm whether the transaction to fund the loan has been acknowledged by the blockchain. Once acknowledged, the status indicator 502 may be updated to funded.

The cancel option 526 may be used to cancel the loan. In some embodiments, the cancel option 526 may not appear until the lender has sent principal to the smart contract and waited for a period of time after a payment is due for the lender to make payments. For example, after a payment is due, the lender may need to wait 3 days for the cancel option 506 to become available on the second settlement interface 520.

In some embodiments, the smart contract may automatically cancel the loan if the borrower has not made payment within a period of time. For example, after a payment is due, if the payment is not made within 5 days, the smart contract may automatically cancel the loan.

The claim funds option 528 may not appear payments are made to the smart contract or the loan is cancelled. For example, the lender may claim any payments made until the loan was cancelled as well as the collateral.

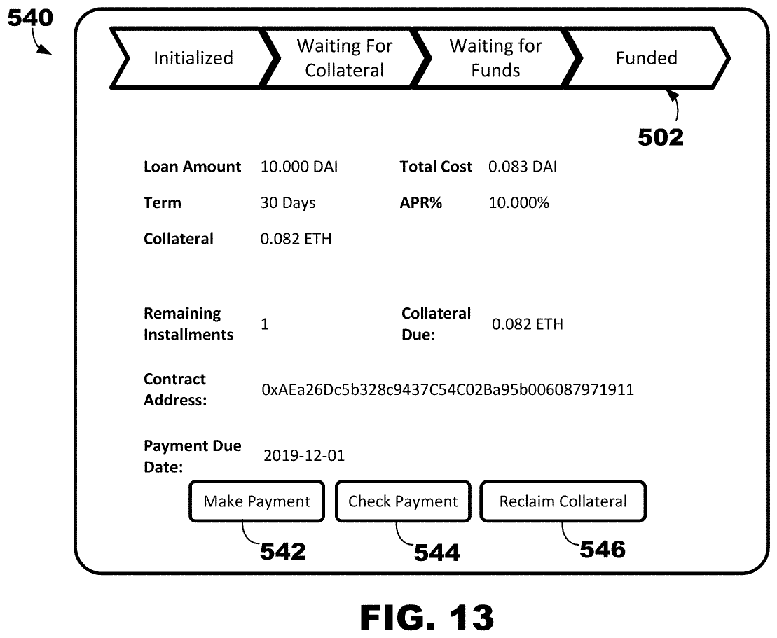

FIG. 13 is a conceptual diagram showing one example of a third settlement interface 540 that may be displayed on the user interface system 150 (FIG. 3) after a lender sends principal to the smart contract. The third settlement interface 540 may be displayed after the second settlement interface 520 and after the first settlement interface 500. The third settlement interface 540 may be displayed to the borrower.

In the illustrated embodiment, the current status of the status indicator 502 is a funded loan. This status may automatically update after the lender has sent principal to the smart contract to fund the loan (and after the borrower has sent collateral to the smart contract).

The third settlement interface 540 may display one or more loan parameter values, which may be the same or similar to the loan parameter values shown in the first settlement interface 500 or the second settlement interface 520. The remaining number of installments to be paid may be shown to show the lender the progress of the loan payments. Other information about the loan may also be shown, such as the loan nickname, the loan creation date, and the unique loan identifier (which may be a Layer 2 address, different than the Layer 1 smart contract address).

The smart contract address may also be shown. The smart contract address may be used as an input to a third party DApp, for example, to send crypto assets to the smart contract.

The third settlement interface 540 may also include one or more user selectable elements, such as a make payment option 542, a check payment option 544, and a reclaim collateral option 546. The make payment option 522 may be used to ask the platform to request recordation of a transaction of crypto assets from the borrower to the smart contract to pay an installment of the loan. Once the funds have been sent to the smart contract, the borrower may wait for the next payment to become due.

The check payment option 544 may be used to check the status of the smart contract. For example, to confirm whether the transaction to fund the loan has been acknowledged by the blockchain. Once acknowledged, the remaining installments may be reduced accordingly.

The reclaim collateral option 546 may not appear until all installments are paid on the loan. The status of the loan may be updated to closed.

Thus, various embodiments of blockchain-based, or distributed ledger-based, systems and methods are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out functionality.

As used herein, the term “configured to” may be used interchangeably with the terms “adapted to” or “structured to” unless the content of this disclosure clearly dictates otherwise.

The term “or” is generally employed in its inclusive sense, for example, to mean “and/or” unless the context clearly dictates otherwise. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

All references and publications cited herein are expressly incorporated herein by reference in their entirety for all purposes, except to the extent any aspect directly contradicts this disclosure.

What is claimed is:

1. A method comprising:
receiving offer data relating to an offer to lend or borrow based on input from a first user;
storing the offer data in an off-chain data structure, the offer data comprising loan parameter values including at least a principal amount and a collateral amount;
in response to receiving user input data representing acceptance of the offer from a second user,
requesting recordation of a smart contract on a blockchain based on the offer data, wherein the smart contract comprises at least the principal amount and the collateral amount from the offer data,
confirming a first transaction of the principal amount or the collateral amount from the second user to the smart contract has been recorded on the blockchain,
confirming a second transaction of the principal amount or the collateral amount complementary to the first transaction from the first user to the smart contract has been recorded on the blockchain, and
confirming the smart contract has recorded a third transaction releasing the principal amount on the blockchain in response to confirming both the first transaction and the second transaction.

2. The method according to claim 1, further comprising:
in response to confirming the smart contract has been recorded to the blockchain based on the offer data, requesting recordation of the first transaction on the blockchain; and
requesting recordation of the second transaction on the blockchain.

3. The method according to claim 1, further comprising:
in response to receiving user input data representing a counteroffer from the second user,
receiving counteroffer data based on input from the second user,
storing the counteroffer data in the off-chain data structure, the counteroffer data comprising at least one different loan parameter value than the offer data, and
providing the counteroffer data to notify the first user of the counteroffer.

4. The method according to claim 3, further comprising:
in response to receiving user input data representing acceptance of the counteroffer from the first user,
requesting recordation of a smart contract on a blockchain based on the counteroffer data, wherein the smart contract comprises at least the principal amount and the collateral amount from the counteroffer data,
confirming a first transaction of the principal amount or the collateral amount from the first user to the smart contract has been recorded to the blockchain,
confirming a second transaction of the principal amount or the collateral amount complementary to the first transaction from the second user to the smart contract has been recorded to the blockchain, and
confirming the smart contract has recorded a third transaction releasing the principal amount in response to confirming both the first transaction and the second transaction.

5. The method according to claim 1, wherein when the first user is a borrower and the second user is a lender, the first transaction comprises the principal amount and the second transaction comprises the collateral amount.

6. The method according to claim 1, wherein when the first user is a lender and the second user is a borrower, the first transaction comprises the principal amount and the second transaction comprises the collateral amount.

7. The method according to claim 1, wherein the blockchain is a permission-less blockchain.

8. The method according to claim 1, wherein the offer data further comprises one or more of: an interest rate, a loan term, a loan total cost, a number of installments, a principal unit type, and a collateral unit type.

9. The method according to claim 8, further comprising automatically determining a minimum collateral amount based on at least the principal amount, the principal unit type, and the collateral unit type.

10. A system comprising:
an off-chain computing system comprising processing circuitry and memory to store an off-chain data structure, the off-chain computing system configured to:
receive offer data relating to an offer to lend or borrow based on input from a first user,
store the offer data in the memory of the off-chain computing system, the offer data comprising loan parameter values including at least a principal amount and a collateral amount, and
receive selection data representing acceptance of the offer based on input from a second user; and
an on-chain computing system comprising processing circuitry and memory, the on-chain computing system configured to:
request recordation of a smart contract on a blockchain based on the offer data, wherein the smart contract comprises at least the principal amount and the collateral amount from the offer data stored in the memory of the off-chain computing system,
confirm a first transaction of the principal amount or the collateral amount from the second user to the smart contract has been recorded on the blockchain,
confirm a second transaction of the principal amount or the collateral amount complementary to the first transaction from the first user to the smart contract has been recorded on the blockchain, and
confirm the smart contract has recorded a third transaction releasing the principal amount on the blockchain in response to confirming both the first transaction and the second transaction.

11. The system according to claim 10, wherein the on-chain computing system is further configured to:
request recordation of the first transaction on the blockchain; and
request recordation of the second transaction on the blockchain.

12. The system according to claim 10, wherein the off-chain computing system is further configured to:
receive counteroffer data relating to a counteroffer based on input from the second user;
store the counteroffer data in the off-chain data structure, the counteroffer data comprising at least one different loan parameter value than the offer data; and
provide the counteroffer data to notify the first user of the counteroffer.

13. The system according to claim 12, wherein the on-chain computing system is further configured to:
request recordation of a smart contract on a blockchain based on the counteroffer data, wherein the smart contract comprises at least the principal amount and the collateral amount from the counteroffer data.
confirm a first transaction of the principal amount or the collateral amount from the first user to the smart contract has been recorded to the blockchain,
confirm a second transaction of the principal amount or the collateral amount complementary to the first transaction from the second user to the smart contract has been recorded to the blockchain, and
confirm the smart contract has recorded a third transaction releasing the principal amount in response to confirming both the first transaction and the second transaction.

14. The system according to claim 10, wherein when the first user is a borrower and the second user is a lender, the first transaction comprises the principal amount and the second transaction comprises the collateral amount.

15. The system according to claim 10, wherein when the first user is a lender and the second user is a borrower, the first transaction comprises the principal amount and the second transaction comprises the collateral amount.

16. The system according to claim 10, wherein the blockchain is a public blockchain.

17. The system according to claim 10, wherein the offer data further comprises one or more of: an interest rate, a loan term, a loan total cost, a number of installments, a principal unit type, and a collateral unit type.

18. The system according to claim 17, further comprising automatically determining a minimum collateral amount based on at least the principal amount, the principal unit type, and collateral unit type.

19. A user interface system comprising:
a display to receive display data and display information to a user;
a user input apparatus to receive user inputs and provide user input data;
a communication interface to send and receive data operably couplable to an off-chain computing system and an on-chain computing system for blockchain recordation; and
processing circuitry operably coupled to the display to provide display data, to the user input apparatus to receive user input data, and to the communication interface to send and receive data, the processing circuitry configured to:
display a marketplace interface to lend or borrow on the display,
display one or more offers to lend or borrow in the marketplace interface based on offer data from the off-chain computing system, each offer comprising a principal amount, a principal unit type, a collateral amount, a collateral unit type and at least one of: an interest rate, a loan term, a loan total cost, and a number of installments,
display an acceptance area selectable by the user to accept one of the one or more offers,
display a counteroffer area selectable by the user to provide a counteroffer to one of the one or more offers,
in response to selection of the acceptance, provide data to the on-chain computing system to record a smart contract to a blockchain based on offer data corresponding to the accepted offer, and
in response to selection of the counteroffer,
display a counteroffer interface for a user to input counteroffer data, and
provide counteroffer data to the off-chain computing system.

20. The user interface system according to claim 19, wherein the processing circuitry is further configured to:
display an offer interface for a user to input offer data; and
reject the offer data in response to the principal unit type and the collateral unit type being the same.
